(19) United States
(12) Patent Application Publication
(10) Pub. No.: US 2023/0257836 A1
(43) Pub. Date: Aug. 17, 2023

(54) PROCESS FOR COATING VEGETABLE-TANNED LEATHERS

(71) Applicant: CHIORINO TECHNOLOGY S.P.A., Milano (IT)

(72) Inventor: Marco TOSCANO, Vigevano (Pavia) (IT)

(21) Appl. No.: 18/002,990

(22) PCT Filed: Jun. 22, 2021
(86) PCT No.: PCT/IB2021/055493

§ 371 Date: Dec. 22, 2022

(30) Foreign Application Priority Data
Jun. 25, 2020 (IT) 102020000015334

(51) Int. Cl. C14C 11/00; C09J 5/02; C09J 7/40; C09J 7/25; C09J 7/38; C14B 1/46; B32B 37/12; B32B 37/24; B32B 38/00; B32B 9/02; B32B 9/06

(52) U.S. Cl. CPC C14C 11/006; B32B 9/06; B32B 9/025; B32B 37/12; B32B 37/24; B32B 38/0012; C09J 5/02; C09J 7/25; C09J 7/38; C09J 7/405; C14B 1/46; B32B 2037/243; B32B 2038/0016; B32B 2255/12; B32B 2255/26; B32B 2255/28; B32B 2307/748; B32B 2317/08; B32B 2317/12; C09J 2400/28; C09J 2475/001; C09J 2475/006

(57) ABSTRACT

A process for coating vegetable-tanned leathers is provided. The process includes depositing a coating layer composed of an aqueous dispersion of polyurethane resin on a support having anti-adhesion properties, curing the coating layer on the support, depositing an adhesive layer composed of an aqueous dispersion of polyurethane resin onto the cured coating layer, applying a leather piece onto the adhesive layer, the leather piece being a vegetable-tanned leather piece, in a continuous oven curing the adhesive layer to attach the leather piece to the coating layer, and removing the coated leather piece from the support. Within the continuous oven the leather piece reaches a maximum temperature comprised between 65° C. and 75° C., with a dwell time in the oven comprised between 180 and 210 seconds.

The present invention relates to a process for coating vegetable-tanned leathers.

Given the growing market demand for products with low environmental impact, there is a trend to apply various film finishes on leathers using sustainable tanning systems, such as chrome-free or metal-free tanning.

It was therefore decided to apply a protective film finish and possibly also an aesthetic finish to substrates deriving from the most eco-sustainable tanning system of all: vegetable tanning.

Leathers from vegetable tanning go through a process in which the so-called tanning agents are tannins, natural extracts derived exclusively from plant sources such as chestnut or birch wood or quebracho, gall nuts, Tara pods, etc.

Vegetable tanning, on the one hand, gives the leather a “natural” appearance, much appreciated by the market; however, on the other hand, it presents some intrinsic limitations to the very nature of the tanning process, such as, for example: very low chemical-physical strength characteristics, which are lower than those required on average by the market; extensive and very frequent surface defects, which therefore make the cutting yield very low; or even a reduced reproducibility of the appearance on a large scale. It is therefore a highly regarded leather that is very expensive and usable mostly on an artisan scale.

There is therefore the need to make an industrial product that maintains a typically artisan value, increasing, at the same time, the physical mechanical properties and determining, for the manufactured goods that result, a greater durability.

In this regard, from the Applicant’s own document IT TO 950 145 A1, a process for coating leathers is known, including the following steps:
depositing a coating layer composed of a mixture of polyurethane resin and solvent on a support with release properties,
allowing the coating layer to cure on the support,
depositing an adhesive layer composed of a mixture of polyurethane resin and solvent on the cured coating layer,
placing a leather piece in contact with the adhesive layer,
in a continuous oven, allowing the adhesive layer to cure to bond the leather piece to the coating layer, and
separating the coated leather piece from the support.

The process described in IT TO 950 145 A1 is designed for mineral-tanned leathers, in particular chrome-tanned leathers. It is therefore not suitable for vegetable-tanned leathers. Vegetable tanning, in effect, as a result of the use of tanning agents of tannic origin, gives the leather a limited stability to thermal stress. For this reason, any finishing process that exposes the vegetable leather to a major source of heat leads to a deterioration of said leather, which compromises its stability over time and even its use in the production of manufactured goods.

One of the most immediate consequences of the effects of temperature on the leather, without reaching more severe levels of deterioration, demonstrated by a clear change in coloration, is in effect identifiable through a natural shrinkage of the fibers due to the loss of moisture content.

An object of the present invention is to provide a process for finishing vegetable-tanned leathers.

Therefore, the invention relates to a process for coating vegetable-tanned leathers, comprising the following steps:
subjecting a vegetable-tanned leather piece to a buffing operation using paper of grit size between 80 and 600 FEPA units,
depositing a coating layer composed of an aqueous dispersion of polyurethane resin on a support release paper having anti-adhesion properties, said support release paper having a predetermined feed rate,
curing the coating layer on the support release paper,
depositing an adhesive layer composed of an aqueous polyurethane resin dispersion onto the cured coating layer,
placing said leather piece in contact with the adhesive layer,
in a continuous oven, curing the adhesive layer to bond the leather piece to the coating layer, and
removing the coated leather piece from the support release paper,
wherein the feed rate of the support release paper is adjusted whereby the leather piece has a dwell time in the continuous oven comprised between 180 and 210 seconds, and the continuous oven is adjusted whereby the leather piece reaches a maximum temperature of between 65° C. and 75° C.

The Applicant has discovered that with the aforesaid process it is possible to finish vegetable leathers in an optimal way, preserving their unique characteristics and at the same time giving them excellent properties of mechanical strength and industrial reproducibility.

Further features and advantages of the process according to the invention will become apparent from the following detailed description of an embodiment of the invention, made with reference to the accompanying drawings, provided for illustrative and non-limiting purposes only, wherein:

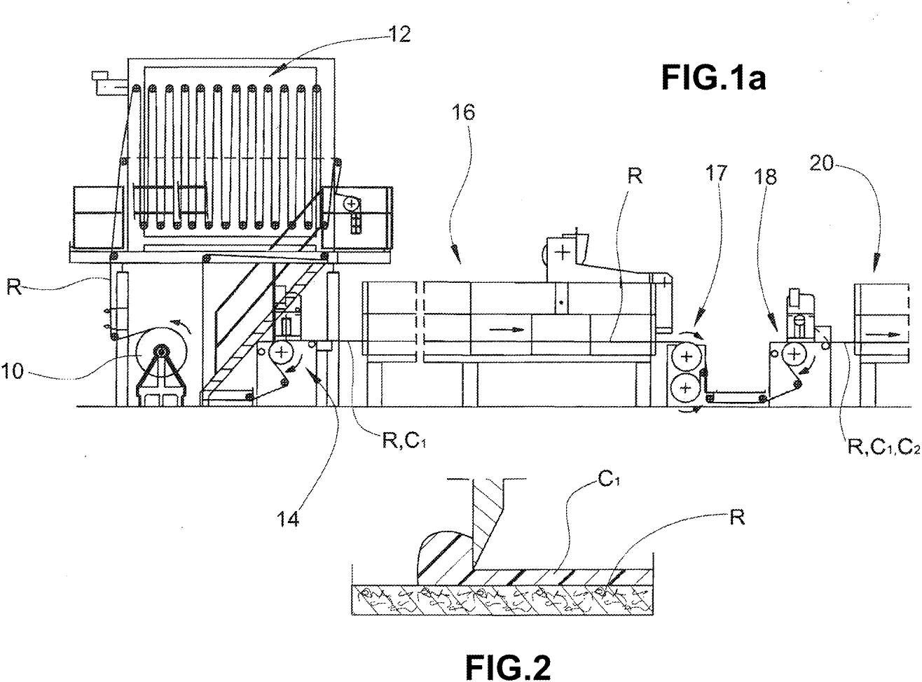

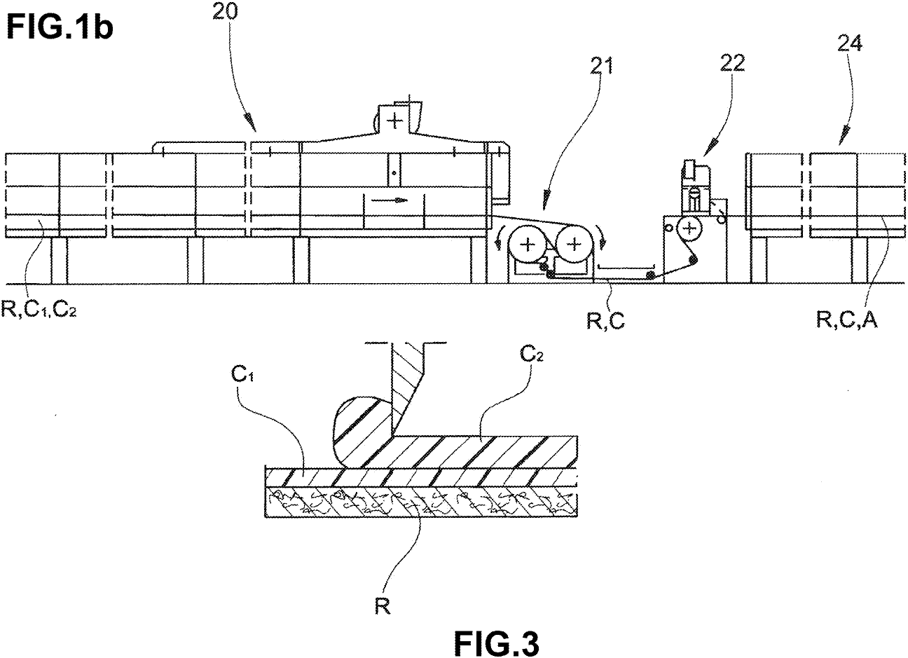

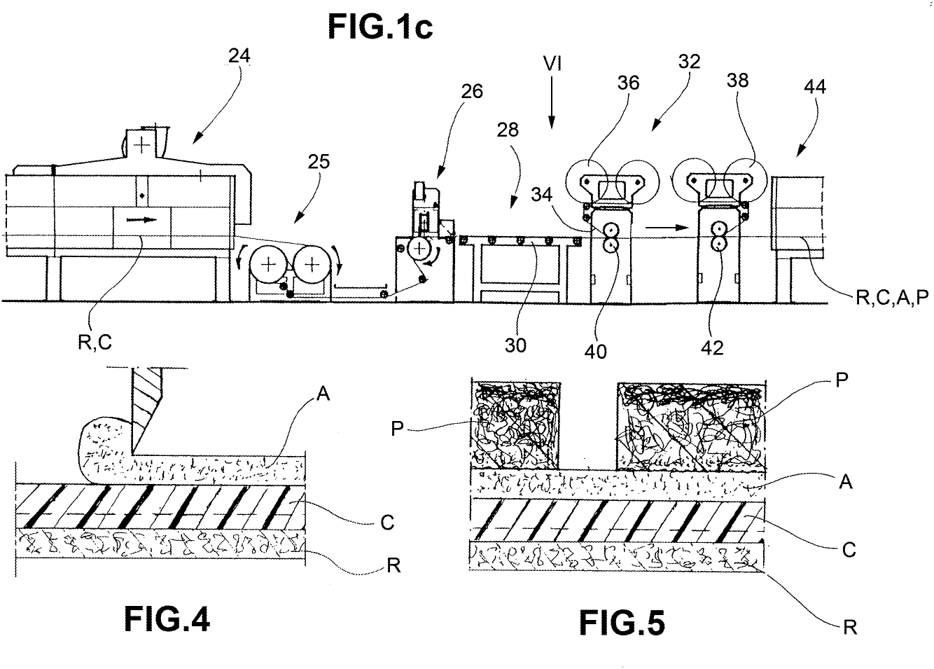

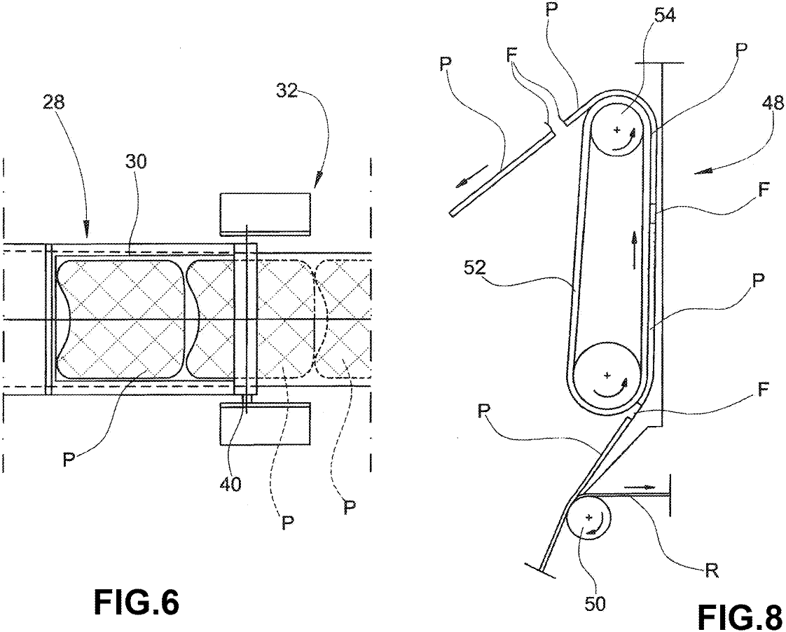

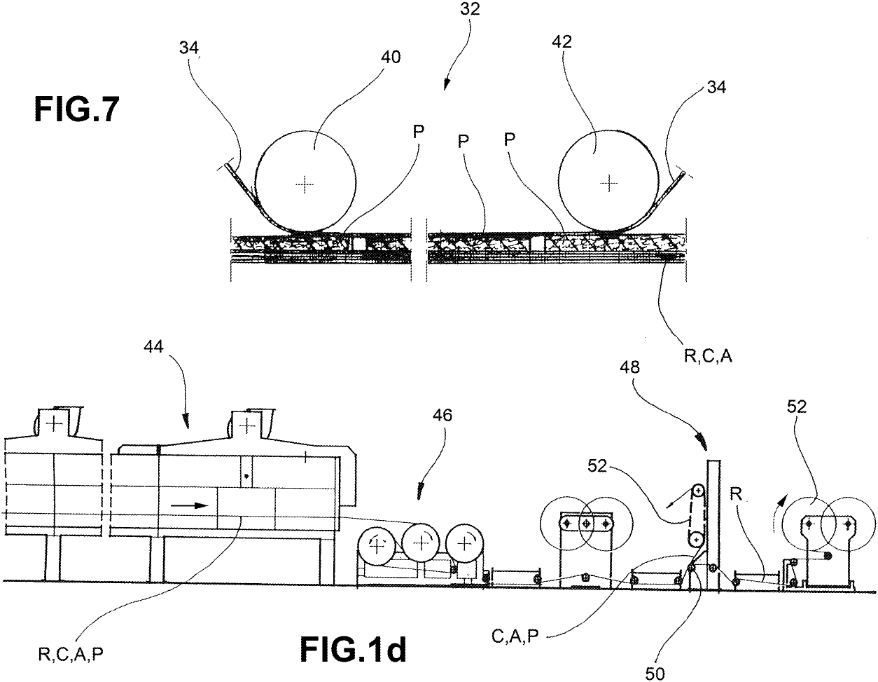

FIGS. 1a, 1b, 1c, 1d collectively represent a schematic side elevation view of a known plant for coating leathers wherein the implementation of the process according to said invention takes place starting from the left of FIG. 1a and ending on the right of FIG. 1d;

FIGS. 2 to 5 are partial schematic cross sections, with greatly exaggerated thicknesses, illustrating the successive stages of applying the layers of leather pieces to a support strip;

FIG. 6 is a schematic plan view from above at a larger scale of the area of the plant shown in VI in FIG. 1c;

FIG. 7 is a schematic side elevation view of the area of the plant shown in FIG. 6;

FIG. 8 is a partial vertical schematic cross section of a stripping station illustrated in FIG. 1d; and

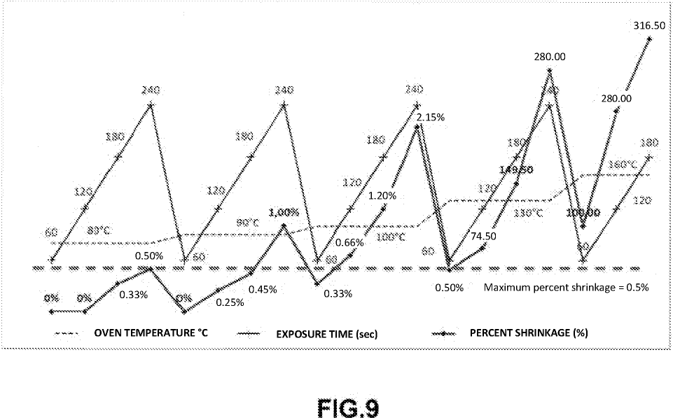

FIG. 9 is a graph showing experimental curves of leather shrinkage as a function of the dwell time in the continuous oven, for different temperature values.

The process according to the invention starting from the beginning of the plant, on the left in FIG. 1a, to its end, on the right in FIG. 1d, will now be described.

In these figures, the directions of rotation of the main rotating parts are indicated by arcuate, unreferenced arrows.

The plant and the process described below make it possible to obtain a vegetable-tanned leather covered with a coating layer, which is coupled to the leather piece by means of an adhesive layer. Vegetable-tanned leather is conventionally defined as leather tanned with vegetable tannins.

The coating (comprising a coating layer and an adhesive layer) is made from a water-based polyurethane resin. For example, such resin may be aliphatic or aromatic polyurethane, polyether-based or polyester-based with dry percentages ranging from 20% to 98%. In the case of the adhesive substrate, polyurethane resins in the aqueous phase of an aliphatic or aromatic nature are used, based on polyether with a dry percentage between 30% and 50%.

Preferably, the coating comprises a water-based, bio-based aliphatic or aromatic polyurethane resin having polyols derived from renewable sources with a percentage ranging from 40% to 90%. They are dispersed in the aqueous phase and the temperature of use ranges from 60° C. to 160° C.

The total weight of the finishing substrate (coating layer plus adhesive layer) ranges from 50 g/m² to 140 g/m², of which the adhesive part is between 15 g/m² and 50 g/m².

Since the film that covers the leather has thermoplastic properties, the finished leathers may subsequently be reworked, also by means of hot stamping, among other things, to enhance or improve the aesthetic characteristics of the leather.

The layers that make up the film may be colorless or pigmented to give the leather a desired coloration, different from the natural one.

A support strip R runs in the described plant, which runs in the direction indicated by several unreferenced linear arrows.

The strip R is made of a material having release properties and preferably is comprised of a strong paper strip, known to persons skilled in the art as “release paper.”

The strip R unwinds from a feed cylinder 10, passes through a buffer 12, and reaches a first coating station 14. At this first station 14, as shown in FIG. 2, a first coating layer C₁ or so-called “pre-skin” coating, comprised of an aqueous dispersion of polyurethane resin, is applied to the strip R.

The strip R then passes through a first continuous drying oven 16, where the layer C₁ undergoes curing.

At the exit of the oven 16, the strip R passes through a pulling unit 17 and then through a treatment station 18. This station 18 may be used as an additional coating station or as a finishing station to impart a pattern or color effect to the first coating layer C₁.

The coated tape then passes through a second drying oven 20, which is only used if a subsequent layer of the same material (not shown) has been applied to the layer C₁.

At the exit from the second oven 20 the strip passes through a pulling unit 21 and then through a further coating station 22 where, as shown in FIG. 3, a second coating layer C₂ of similar composition to the first layer C₁ is applied over the first dried coating layer C₁. The strip coated as in FIG. 3 then passes into a third continuous drying oven 24 having substantially the same features as the first oven 16.

At the exit from the oven 24 the two dried layers C₁ and C₂, which are of the same nature, are practically fused together, as shown in C in FIG. 4, to form, as will be seen later, the final coating of the pieces of the leather.

At the exit of the second oven 20, the strip R carrying the complete dried coating layer C passes through a pulling unit 25 and then through a final coating station 26 where a layer of adhesive A is applied to the layer C in the fluid state, comprised of an aqueous dispersion of polyurethane resin.

When necessary, a third coating stage C₃, identical to the second, may be used if it is available and installed to supplement the system (not shown). The specifications of coating thicknesses and the operation of the process are the same as for the production of the layer C₂.

While the adhesive of the layer A is still fluid or softened, the strip passes through a coupling station 28, also visible in FIG. 6.

The coupling station essentially comprises a flat table 30 on which the coated strip R slides.

As the coated strip slides off the table 30, an operator or a dedicated machine (not shown) applies successive leather pieces P to the adhesive layer A, with the grain side or flesh side in contact with said adhesive. Said leather pieces P have been preliminarily subjected to a buffing operation with a paper grit size between 80 and 600 FEPA units (Fédération Européenne des Fabricants de Produits Abrasifs), and preferably also to a staking operation, which may comprise from one to four cycles depending on the hand of the leather and the type of article to be finished. The aforesaid processes help to prepare the leather piece for adhesion with the coating.

Downstream of the table 30, the strip passes through a calendering station 32 which serves to exert pressure to adhere the leather pieces P on the adhesive layer A.

In the case shown, as may be seen in FIG. 7, the calendering station 32 comprises a paper strip 34 that unwinds from a cylinder 36 and rewinds onto a cylinder 38.

The strip 34 passes, along with the plurality of coupled layers R, C, A, P, between pairs of motorized pressure rollers 40 and 42.

Alternatively, the calendering station could simply comprise one or more pairs of pressure rollers.

In particular, the pair of motorized pressure rollers 40 at the inlet of the calendering station 32 preferably comprises a roller having a surface with a high hardness, for example made of steel, and a counter-roller having a surface with a lower hardness, for example made of an elastomeric material, to accompany the strip R with the coupled layers so as to avoid the formation of creases or defects.

Once the leather pieces P have been firmly adhered to the adhesive layer A in the calendering station, the composite strip R, C, A, P passes through a final continuous drying oven 44, in which the setting or curing of the adhesive of the layer A takes place.

While the conditions of the preceding ovens 16, 20, 24 are not critical, the drying oven 44 must meet rather stringent conditions, which will now be specified. These conditions were determined experimentally as described below.

For curing the adhesive of the layer A, hot air is circulated in the oven 44, whereby the temperature of the leather P does not exceed 75° C., and the exposure time to such temperature is between 180 and 210 seconds. With an oven length of 17 m, this implies that the feed rate of the strip is between about 4.9 and about 5.5 m/min.

At the exit of the oven 44, the composite strip R, C, A, P on which, due to the curing of the adhesive, the leather pieces P are glued, passes through a pulling unit 46 and reaches a detachment station 48, best seen in FIG. 8.

In the detachment station 48 the incoming composite strip first passes over a roller 50 where the set of layers formed of the coating C, the adhesive A and the leather pieces P are detached from the support strip R. The support strip R continues horizontally until it is finally wound onto a rewinding cylinder 52 (FIG. 1d) to be recovered.

On the other hand, the set of layers C, A, P continues vertically on an endless belt conveyor 52.

Along the vertical path the successive leather pieces are again joined together by the thin film formed by the layers of coating C and adhesive A, as shown in F in FIG. 8.

At the top of the circulation path of the conveyor belt 52, said conveyor belt passes over a return cylinder 54, while the strip comprised of the leather pieces P and the film F is detached from said strip, for example by an operator A. Following the pulling on the leather pieces P, the film F interlinking them splits and the coated leather pieces may be picked up and stacked one by one and removed from the plant.

### EXPERIMENTAL PART

As indicated above, one of the most immediate consequences of the effects of temperature on leather is a natural shrinkage of the fibers due to the loss of moisture content. The inventors have used this parameter to evaluate the stability of vegetable leathers after heat treatment, arriving at establishing as optimal the window of thermal stress that determines a maximum shrinkage of the leather of 0.5%, identified as the maximum limit of heat shrinkage in order not to be subject to an intrinsic degradation, with loss of stability and of the unique characteristics of hand and reproducibility in the finished product.

In order to define the optimal process for the applicability of the process to vegetable tanning, numerous dimensional stability tests were performed. The main variables were the temperature and speed of the coating belt and then, once the length of the oven was set (17 linear meters for the sample at hand), the exposure time of the leather.

The study was carried out by detecting the temperatures directly on the leather, through a measurement with contact thermometers, which were naturally lower than those of the ovens, due to the thermal inertia of the heating process of said leather. Given the very low thickness of the leather pieces used, less than 2 mm, the effect determined by the heat diffusion inside said leather piece was considered negligible.

The variable belt speed gave origin to different dwell times in the oven, which were interpolated with the temperatures measured on the leather piece and the percent shrinkage value of the leather examined.

The table below shows, as an indication, some of the temperatures measured on the leather as a function of oven temperature, at a dwell time interval between 60 and 240 seconds.

TABLE 1

| | |
|---|---|
| TEMPERATURE IN THE OVEN | TEMPERATURE DETECTED ON THE LEATHER PIECE |
| 80° C. | 60-65° C. |
| 90° C. | 68-76° C. |
| 100° C. | 77-88° C. |
| 130° C. | 93-100° C. |
| 160° C. | 127-140° C. |

Numerous tests were then performed at different oven temperatures, varying the dwell time of the leather, and identifying the resulting average percent shrinkage. Below are some measured values corresponding to a set temperature range between 80° C. and 160° C.

TABLE 2

| SET TEMPERATURE °C | EXPOSURE TIME (sec) | % AVERAGE SHRINKAGE |
|---|---|---|
| 80 | 60 | 0 |
| 80 | 120 | 0 |
| 80 | 180 | 0.33 |
| 80 | 240 | 0.5 |
| 90 | 60 | 0 |
| 90 | 120 | 0.25 |
| 90 | 180 | 0.45 |
| 90 | 240 | 1 |
| 100 | 60 | 0.33 |
| 100 | 120 | 0.66 |
| 100 | 180 | 1 |
| 100 | 240 | 2.00 |
| 130 | 60 | 0.495 |
| 130 | 120 | 0.745 |
| 130 | 180 | 1.495 |
| 160 | 60 | 1 |
| 160 | 120 | 2.33 |
| 160 | 180 | 3.165 |
| 80 | 60 | 0 |

It should be noted that the percent shrinkage of the leather varies significantly by increasing the dwell time, showing an even threefold effect on the worsening of the reference parameter of the degradation process. At the same time, the dwell time may not be too short, for reasons intrinsic to the multi-head coating process, which in effect provides for optimal and concomitant regulation of film deposition and curing relative to each stage at constant belt speed. It was therefore necessary to find the ideal compromise between dwell time and temperature to which the leather is subjected in the oven.

The process of optimization is schematized in summary in the diagram of FIG. 9. The area subtended by the horizontal line positioned at 0.5% shrinkage represents the zone at which the vegetable leather is intrinsically stable. The tests reported were carried out at temperatures ranging from 80° C. to 160° C. The dwell times, a function of belt speed, were modulated between one and four minutes (60-240 seconds). At each preset temperature, the percent shrinkage of the vegetable leather was measured as the belt speed varied. It should be noted that, once a certain oven temperature was set and the dwell time increased, the percent shrinkage of the leather (P), which is directly proportional to the instability induced in the same leather, increases significantly, up to determining values that exceed the threshold limit of 0.5%. It should also be noted that, at oven temperatures above 90° C., corresponding to temperatures on the leather up to 75° C., the curve of percent shrinkage almost immediately exceeds the value of 0.5%, causing a situation of induced instability on the leather. It was therefore possible to determine that the maximum temperature to which the vegetable leather may be subjected during the production cycle at speeds compatible with the complete coating process, set in the range 4.9-5.5 meters/min, is 90° C. Processing cycles at lower temperatures (for example 80° C., corresponding to maximum temperatures measured on the leather of 65° C.) may allow dwell times even higher than 180-210 seconds, to the detriment of productivity and optimization of the process of vulcanization of the layers C₁, C₂, C₃ and A.

What is claimed is:

1. A process for coating vegetable-tanned leather, the process comprising :
buffing a vegetable-tanned leather piece with paper of grit size comprised between 80 and 600 FEPA units,
depositing a coating layer composed of an aqueous dispersion of polyurethane resin onto a support release paper having anti-adhesion properties, said support release paper having a predetermined feed rate,
curing the coating layer on the support release paper,
depositing an adhesive layer composed of an aqueous dispersion of polyurethane resin onto the cured coating layer,
applying said vegetable-tanned leather piece onto the adhesive layer,
in a continuous oven, curing the adhesive layer to bond the vegetable-tanned leather piece to the coating layer, and
removing the coated vegetable-tanned leather piece from the support release paper,
wherein the predetermined feed rate of the support release paper is adjusted whereby the vegetable-tanned leather piece has a dwell time within the continuous oven comprised between 180 and 210 seconds, and the continuous oven is adjusted whereby the vegetable-tanned leather piece reaches a maximum temperature comprised between 65° C. and 75° C.

2. The process of claim 1, wherein said vegetable-tanned leather piece, before being applied onto the adhesive layer, is subjected to a staking operation.

3. The process of claim 1, wherein the polyurethane resin of the coating layer and of the adhesive layer is an aliphatic or aromatic polyether-based polyurethane resin with a weight percentage ranging from 40% to 90% derived from renewable sources.
